(19) United States
(12) Patent Application Publication
(10) Pub. No.: US 2010/0028510 A1
(43) Pub. Date: Feb. 4, 2010

(54) DISINFECTION OF DRIED FOODSTUFFS

(75) Inventors: Lee C. Ditzler, Diablo, CA (US); Cliff M. Coles, Brentwood, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: INVENX, Pleasanton, CA (US)

(21) Appl. No.: 12/184,845

(22) Filed: Aug. 1, 2008

(51) Int. Cl. A23L 3/3454

(52) U.S. Cl. 426/331; 426/335

(57) ABSTRACT

Nuts, grains, seeds and other dry or dried foodstuffs are disinfected by a process that entails infusion with gaseous ozone and treatment with liquid non-ozone disinfectant, each treatment being preceded by a decompression of the foodstuffs to a pressure below atmospheric and each treatment utilizing an inert gas to achieve the exposure to the treatment agents at a pressure above atmospheric. The process achieves control of infestations at substantially all stages of the life cycle of pests, bacteria, and mold byproducts with which the product may be infested, and can do so in less than an hour.

### BACKGROUND OF THE INVENTION

1. Field of the Invention

This invention resides in the technology of treating dried foodstuffs to reduce levels of bacteria, mold byproducts, and pest infestation.

2. Description of the Prior Art

The various methods currently in use for controlling bacteria, mold byproducts, and pests in dried foodstuffs such as nuts, grains, seeds, and dried fruits and vegetables generally involve fumigation extending over several days, and even then, the treatments tend to kill only live mature organisms and insects, leaving the products vulnerable to reinfestation within a few weeks. The difficulties in achieving adequate disinfection are illustrated by products that are infested with the insects, bacteria, or both, where conventional fumigation does not fully treat the surfaces or penetrate the products. Nuts, grains, and seeds require aggressive fumigation since many species are grown in environments that result in products with high bacterial counts, mold byproducts, or insects within the products. Adding to the difficulty is the bulk handling and packaging of rice, corn, and other grains, as well as nuts, seeds, and other such products, all tightly packed, making much of the product surfaces inaccessible for treatment.

### SUMMARY OF THE INVENTION

It has now been discovered that dried foodstuffs, also referred to herein as “product” or “products,” can be treated for bacterial and pest infestations in a thorough and efficient manner by a process that includes gaseous ozone infusion and contact with a liquid disinfectant. In certain embodiments, these treatments are preceded by exposure of the product to hot moisture. In general, the process is performed in a sequence that includes rapid decompression of the product before contact is made with either the ozone or the liquid disinfectant and then a rapid re-pressurization with an inert gas to a superatmospheric pressure that is maintained during the contacts with ozone and the liquid disinfectant. It is preferred that the ozone treatment precede the treatment with the liquid disinfectant, and that each treatment be performed in a separate decompression and pressurization cycle. The liquid disinfectant, which is a species other than ozone, can be applied as a mist. Any of a wide range of known liquid disinfectants can be used, including those whose use is not in conflict with characterization of the product as having been organically grown and treated. Contact between the product and the treatment agents, as well as the decompressions and pressurizations, can be performed in a simple rotating drum to provide a tumbling or agitating effect that continuously exposes fresh surface area of the product to the treatment atmosphere, and the drum can continue to rotate through the entire succession of stages for each batch of product to be treated.

Each stage of the treatment sequence can be fully performed in minutes rather than days or even hours, thus permitting the treatment of large quantities of product in a single day. Since the process is effective in deactivating infectious organisms at all, or substantially all, stages of the life cycle of the organisms, reinfestation rates are very low.

### BRIEF DESCRIPTION OF THE DRAWINGS

FIG. 1 is a cross section of an example of a treatment chamber that can be used in the practice of the invention.

FIG. 2 is a block diagram of an example of a process sequence within the scope of the invention.

FIG. 3 is an example of a process flow diagram for a plant or treatment unit for practicing the invention.

### DETAILED DESCRIPTION OF THE INVENTION AND PREFERRED EMBODIMENTS

As noted above, a preliminary step in certain embodiments of the invention is the exposure of the product to hot moisture. This will increase the surface moisture of the product which in certain cases will enhance the effectiveness of the ozone in killing bacteria and mold. The hot moisture can be applied in the form of steam at atmospheric pressure, or by simply contacting the product with water vapor or a gas mixture containing water vapor, at a temperature above ambient temperature but below the boiling point of water. The exposure time will be less than that which will result in cooking of the product, and the optimal exposure time will vary with the particular product being treated. In general, the use of steam at atmospheric pressure for a period ranging from about ten seconds to about one minute will suffice. Among the products that will benefit from this preliminary hot moisture treatment are almonds and nuts in general.

The rapid decompression that precedes the ozone treatment will remove any plugs or obstructions in the products that shield or cause retention of undeveloped life forms such as larvae and eggs, and is performed at a rate sufficiently fast and to a pressure sufficiently low to achieve this effect. The rate and final pressure may vary with the foodstuffs being treated as well as the nature of the infestation. In most cases, however, effective results will be achieved by evacuation (decompression) to about minus 10 inches of mercury (10 psia, 69 kPa) or less, preferably minus 20 inches of mercury (4.9 psia, 34.5 kPa) or less, at a rate by which the final pressure is achieved in one minute or less, preferably 30 seconds or less, and most preferably 10 seconds or less. (Pressure reductions to subatmospheric pressures are referred to herein as “evacuations,” which term is used herein to include partial vacuums.) The initial evacuation is generally performed from atmospheric pressure, and evacuations following pressures that are elevated above atmospheric are from those elevated pressures. Practical lower limits for the pressure and evacuation rate ranges cited above are about 0.5 psia for the reduced pressure and about 0.5 second for the evacuation time.

Once the reduced pressure is attained, it is preferably maintained for a period of time before the ozone infusion is begun. As presently contemplated a holding time ranging from 0.2 minute to 60 minutes will generally suffice, preferably from 0.5 minute to 20 minutes, and most preferably from 1 minute to 5 minutes.

Ozone infusion into the evacuated product can be performed with ozone gas from any of the known types of ozone generators. Included among these generators are those operating by corona discharge, high-frequency electrical discharge, ultraviolet light, x-ray, radioactive isotope, and electron beam. Ozone generators utilizing corona discharge and producing ozone from oxygen gas rather than air are preferred. The amount of ozone infused is sufficient to produce an ozone-containing atmosphere around the product in which the ozone concentration is from about 200 to about 100,000 ppm, preferably from about 1,000 to about 10,000 ppm. (All ozone concentrations expressed herein are by volume.) The chamber with the product inside is closed and evacuated, and once the rapid ozone infusion has taken place, contact between the ozone and the product is allowed to continue for at least about 30 seconds, preferably about 30 seconds to about 30 minutes, and most preferably for about 1 minute to about 5 minutes. The chamber is then pressurized with an inert gas by adding the gas to the ozone already present in the chamber, raising the chamber pressure to a level above atmospheric, preferably 20 psia or above, more preferably to a pressure within the range of about 20 psia to about 200 psia, and most preferably the range of about 50 psia to about 100 psia. This elevated pressure is then maintained for at least 30 seconds, preferably for a period of time ranging from about 30 seconds to about 60 minutes, and most preferably from about 1 minute to about 10 minutes. It is also preferred that the pressurization is achieved in one minute or less, preferably from about 0.5 second to about 1 minute. The inert gas is preferably a gas other than argon, or at least a gas that forms a mixture within the chamber that contains less than 1% argon. Nitrogen and carbon dioxide are preferred, but a fturther preferred atmosphere is an inert gas that contains less than 0.5% carbon dioxide. Nitrogen is the most preferred inert gas. As described below, the product in the chamber is preferably agitated or tumbled during the various stages of the process, including the ozone exposure. Once the desired pressure is reached, the ozone exposure occurs in a static atmosphere rather than continuously passing a stream of ozone over the product.

Following the exposure of the product to the ozone under the pressurized condition, decompression is again performed, to about minus 10 inches of mercury (10 psia, 69 kPa) or less, preferably minus 20 inches of mercury (4.9 psia, 34.5 kPa) or less, most preferably minus 25 inches of mercury (2.4 psia, 16.6 kPa) or less, at a rate by which the final pressure is achieved in one minute or less, preferably 30 seconds or less, and most preferably 10 seconds or less. Here again, practical lower limits for the ranges cited above are about 0.5 psia for the final pressure and about 0.5 second for the evacuation time. The reduced pressure is then preferably maintained for a holding time before further treatment is performed. As presently contemplated, a holding time ranging from 0.2 minute to 60 minutes is generally appropriate, preferably from 0.5 minute to 20 minutes, and most preferably from 1 minute to 5 minutes.

The liquid disinfectant is then sprayed as a mist over the product, and the chamber is then pressurized by adding an inert gas to the moistened product. The liquid disinfectant can be any disinfectant that is known for use in treating foodstuffs and that is a liquid at the reduced pressure at which the mist is introduced into the treatment chamber. The quantity of liquid disinfectant is preferably within the range of 0.1 to 100 liters per 2,000 pounds (907 kg) of product, or more preferably 0.25 to 10 liters per 2,000 pounds of product, and most preferably about 2 liters per 2,000 pounds of product. Examples of such liquid disinfectants are ethyl alcohol, parasitic acid, isopropyl alcohol, chlorine dioxide, sodium hypochlorite, and various commercially available disinfectants. The disinfectant can be applied as an aqueous solution or in non-aqueous (but still liquid) form, and as noted above, is preferably applied as a mist. The pressurization following the introduction of the liquid disinfectant raises the chamber pressure to a level above atmospheric, preferably 20 psia (11 inches of mercury above atmospheric, 138 kPa) or above, more preferably to a pressure within the range of about 20 psia to about 200 psia (377 inches of mercury above atmospheric, 1379 kPa), and most preferably the range of about 50 psia (72 inches of mercury above atmospheric, 345 kPa) to about 100 psia (174 inches of mercury above atmospheric, 690 kPa). This elevated pressure is then maintained for at least 30 seconds, preferably for a period of time ranging from about 30 seconds to about 60 minutes, and most preferably from about 1 minute to about 10 minutes. The pressurization is preferably performed within one minute or less, preferably from about 0.5 second to 1 minute. The inert gas can be the same gas as used in the ozone pressurization stage, and nitrogen is particularly preferred. Once this stage of the process is completed, the chamber pressure can be returned to atmospheric pressure, and the chamber opened to recover the treated, disinfected product.

In certain embodiments of the invention, one or both of the decompression-pressurization cycles is repeated one or more times before progressing to the next stage or removing the product from the chamber.

For maximum exposure of all product particles to the treatment agents, the treatments are preferably performed in a drum rotating about a horizontal axis, the drum containing internal baffles to direct the product away from the walls of the drum. Rotation is typically performed slowly for a maximum tumbling effect of the product and to minimize the risk of damage to the product.

The process of the present invention is useful in the disinfection of a variety of dry foodstuffs, examples of which are grains, nuts, dried fruits and vegetables, and seeds. Foodstuffs of particular interest are almonds, rice, and corn.

### EXAMPLE

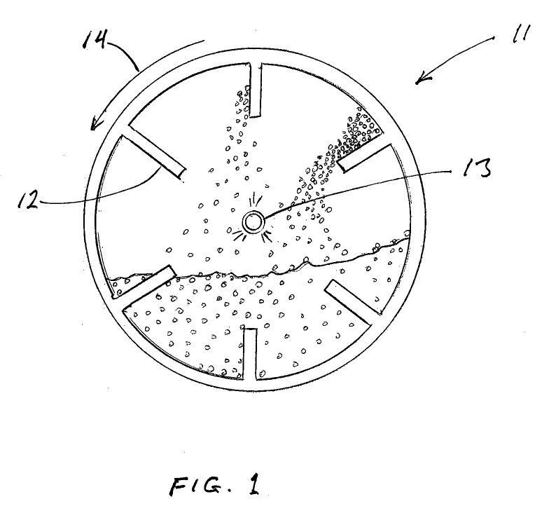

A cylindrical stainless steel drum with tapered ends is used as the treatment chamber. The drum has a port at one end for both filling the drum and discharging material from the drum, with a removable hatch (i.e., closure) over the port. The drum interior is 8 feet (2.4 m) in length and 5 feet (1.5 m) in diameter. It is currently contemplated that drums ranging from 2 to 12 feet (0.6 to 3.7 m) in length and 1 to 10 feet (0.3 to 3 m) in diameter can be used. A cross section of the drum interior is shown in FIG. 1. The drum 11 contains six paddles 12 evenly spaced around the circumference of the drum, each paddle extending the full length of the drum in the axial direction (perpendicular to the plane of the drawing) and extending radially from the inner wall surface of the drum a third of the distance toward the drum axis. Positioned along the drum axis is a center pipe 13 through which all liquids and gases used during the treatment process enter the drum and through which the drum is evacuated and pressurized. The drum is mounted to a frame (not shown) within which the drum can be rotated about a transverse axis between a vertical position in which the center pipe is vertically oriented and a horizontal position in which the center pipe is horizontal. The vertical/horizontal position is controlled by a ram on the frame. At the fill/discharge end (not visible in this view) of the drum are three drive rollers driven by a motor with a gear reducer, while the opposite end of the drum is supported by bearings and rotary seals. The center pipe 13, which contains misting nozzles as well as ports for evacuation and pressurization of the drum, is mounted to the frame to enter the drum through a rotary seal at the bearing end and to remain fixed as the drum rotates. The direction of rotation of the drum during the treatment stages is indicated by the arrow 14.

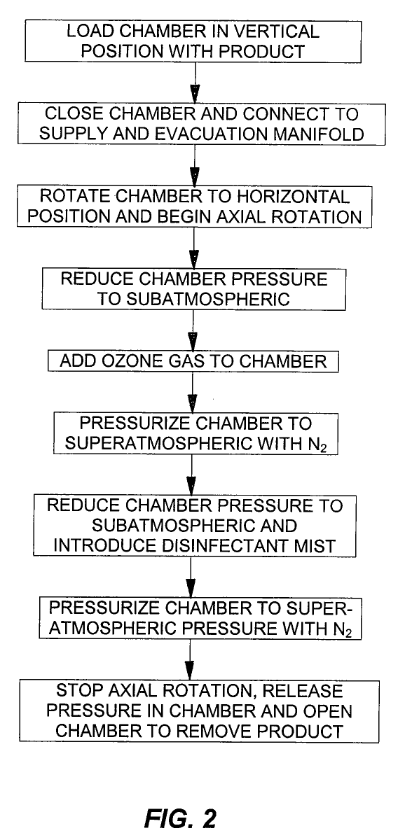

A sequence of operation is shown in FIG. 2. The chamber 11, in its vertical position with the fill/discharge end at the top and the hatch (closure) removed, is loaded with dried product to be disinfected. The amount of product added is that which will fill the chamber to about 45% of the volumetric capacity of the chamber to assure that when the chamber is rotated to its horizontal position, the center pipe 13 is above the product level. Once the product is placed in the chamber, the hatch is replaced, and all connections to the supply and evacuation lines are made through an evacuation/pressurization manifold. The chamber is then rotated to the horizontal position, and rotation about the chamber axis is begun at 3 revolutions per minute. In general, rotation rates of from 0.5 to 60 revolutions per minute can be used, depending on the size of the chamber and the density and type of the product. The chamber is then evacuated within 5 seconds through the center pipe to 22.4 psia (minus 25 inches of mercury) to prepare for the ozone treatment cycle, and ozone gas is directed into the chamber to an ozone level of 3,000 ppm (by volume). The ozone exposure is maintained for 2 minutes, and the chamber is then pressurized with nitrogen gas (while still retaining the ozone) over 5 seconds to 65 psia.

The elevated pressure with nitrogen and ozone is maintained for 3 minutes, after which time the chamber is evacuated to 22.4 psia (equal to minus 25 inches of mercury and to 154 kPa), where the chamber is held for 2 minutes. A mist of the liquid disinfectant is then sprayed onto the product through the misting nozzles in the center pipe at a quantity of 2 liters of the liquid per 1,000 pounds of the product. The chamber is then re-pressurized with nitrogen gas over 5 seconds to 65 psia and the pressure is maintained for 4 minutes. The pressure is then released.

The chamber rotation is then discontinued, and the chamber is then rotated on a transverse axis to a position in which the longitudinal axis of the drum is at an acute angle, such as 20°, with the horizontal, and the hatch is removed, leaving the fill/discharge port open. The chamber is then placed in the vertical position with the open port facing down, and the treated product is withdrawn from the chamber through the port.

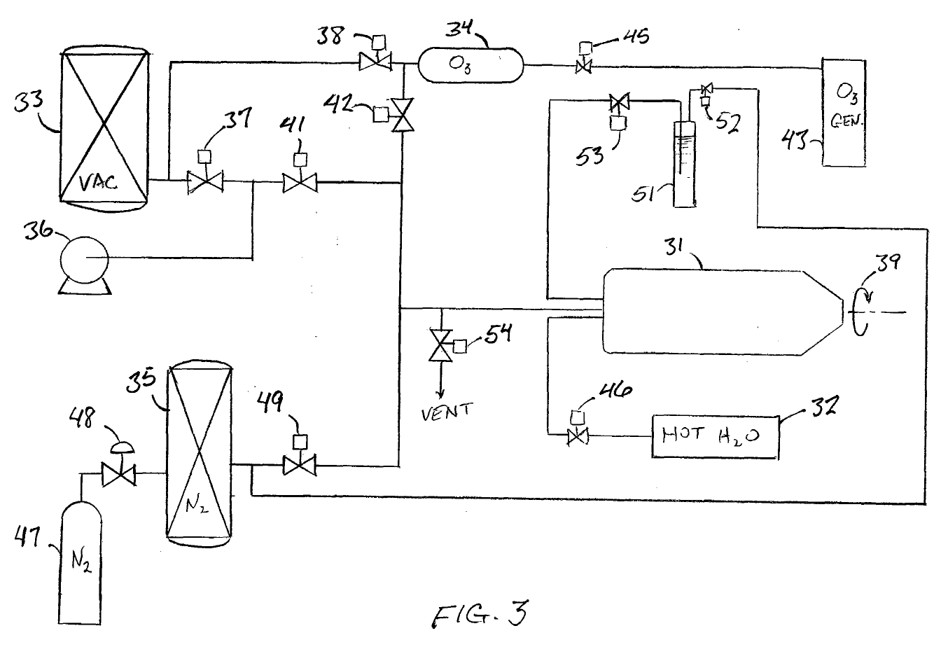

FIG. 3 is an example of a process flow diagram for the process described above. A drum 31 serves as the treatment chamber, and is joined through a network of pipelines and valves to a hot moisture generator 32, a vacuum chamber 33, an ozone storage tank 34 that is cooled by liquid nitrogen, and a pressurized nitrogen tank 35. The drum 31 is initially placed in a vertical position or in a position in which the longitudinal axis of the drum is at an acute angle to the horizontal, and product to be treated is placed in the drum. The drum is then closed and a vacuum pump 36 evacuates the vacuum tank 33 and the ozone storage tank 34 through two open valves 37, 38 while the vacuum tank 33 and the ozone storage tank 34 are isolated from the chamber 31 by additional valves 41, 42 and from an ozone generator 43 by a further valve 45. The drum is then placed in the horizontal position, the valve 38 on the line leading from the vacuum pump 36 to the ozone storage tank 34 is closed, and the valve 45 on the line leading from the ozone generator 43 to the ozone storage tank 34 is opened, allowing ozone to flow into the ozone storage tank 34 to a concentration of 80,000 ppm (by volume). The ozone storage tank 34 has a volumetric capacity sufficient to produce the desired ozone concentration in the drum 31 when the tank 34 releases its contents into the drum.

Axial rotation of the drum 31 in the direction of the arrow 39 is then begun, and a valve 46 on the line leading from the hot moisture generator 32 to the drum 31 is opened, moistening the surfaces of the product in the drum. Once the product surfaces are uniformly moistened, the valve 46 adjacent to the hot moisture generator 32 is closed, and the two valves 37, 41 on the lines between the vacuum tank 33, the vacuum pump 36, and the drum 31 are opened. Due to the low pressure and large volumetric capacity of the vacuum tank 33, this produces a rapid drop in pressure in the drum 31. Once the pressure in the drum 31 equilibrates to that in the vacuum tank 33, the valve 37 is closed, isolating the vacuum tank 33 from the drum 31, while the vacuum pump 36 continues to draw a vacuum on the drum 31, lowering the drum pressure to the desired level. Once the desired pressure is achieved and held for the designated period of time, the valve 41 between the vacuum pump 36 to the drum 31 is closed. The valve 42 joining the ozone storage tank 34 to the drum 31 is then opened, allowing ozone to enter the drum 31 by equilibration of the pressure in the drum to that of the ozone storage tank 34. This condition is maintained for the specified time period, after which the valve 42 is closed.

The pressurized nitrogen tank 35 is supplied with nitrogen from a pressurized nitrogen source 47 through a pressure regulating valve 48, and a further valve 49 is on the line leading from the pressurized nitrogen tank 35 to the drum 31. After the ozone valve 42 is closed, the nitrogen valve 49 is opened to pressurize the drum 31 with nitrogen to 65 psia (102 inches of mercury above atmospheric, 448 kPa). The nitrogen pressure is then maintained in the drum for the specified time period, after which time the drum 31 is evacuated by opening appropriate valves joining the drum to the vacuum tank 33 and the vacuum pump 36. The evacuation condition is maintained for the specified time period. The valves are then closed to isolate the vacuum pump 36 and vacuum tank 33 from the drum 31, and the liquid disinfectant, stored in a tank 51 that is pressurized by the nitrogen tank 35 through a separate valve 52, is then opened to the drum 31 through a liquid supply valve 53, causing the liquid disinfectant to be sprayed as a mist into the drum. After the specified amount of liquid disinfectant has been applied to the product, the supply valve 53 is closed and the drum is again pressurized with nitrogen from the nitrogen tank 35 through the nitrogen supply valve 48. Once the nitrogen pressure is maintained for the specified time period, all valves are closed, and a vent valve 54 is opened to allow the drum 31 to return to atmospheric pressure. Rotation of the drum 31 is then discontinued, the drum is rotated on a transverse axis to a home position in which the drum axis forms an acute angle to the horizontal and the closure of the fill/discharge port is removed. The drum is then rotated back on the transverse axis to a vertical position with the fill/discharge port facing down, and the treated product is removed through the port. The empty drum is then rotated again on the transverse axis until the fill/discharge hatch is at the top, and a fresh batch of product to be treated is placed in the drum. The drum is then rotated to its home position (at an angle to the horizontal), the hatch is then re-installed over the fill/discharge port, and the system is ready to be rotated to the horizontal position to treat the new batch.

In addition to the valves identified above, safety relief valves, pressure regulating valves, and pressure transmitters are positioned at various locations in the lines joining the vessels, and a filter is positioned between the drum 31 and the vacuum tank 33 and vacuum pump 36. Although these valves and transmitters and the filter are now shown in the Figure, their placement is a matter of routine engineering skill, and will be readily apparent to those of skill in the art of chemical processing design.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or otherwise known in the art and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. A process for the disinfection of dry foodstuffs, said process comprising:
(a) placing said foodstuffs in a chamber and evacuating said chamber to a first reduced pressure of about 10 psia or less at a rate by which said first reduced pressure is achieved in one minute or less, infusing said chamber while so evacuated with ozone gas to a concentration ranging from 200 to 100,000 ppm by volume, closing said chamber after said infusion, and maintaining said chamber so closed for a period of time ranging from 0.5 minute to 30 minutes;
(b) adding an inert gas to said chamber after step (a) to pressurize said chamber to a first elevated pressure of at least about 20 psia at a rate by which said first elevated pressure is achieved in one minute or less;
(c) evacuating said chamber after step (c) to a second reduced pressure of about 10 psia or less at a rate by which said second reduced pressure is achieved in one minute or less, contacting said foodstuffs in said chamber while so evacuated with a mist of a liquid disinfectant and adding an inert gas to said chamber after step (b) to re-pressurize said chamber to a second elevated pressure ranging from about 20 psia to about 200 psia at a rate by which said second elevated pressure is achieved in one minute or less to reduce or eliminate any infestation of said foodstuffs remaining after step (b); and
(d) recovering said foodstuffs from said chamber after step (c);
steps (a) through (c) being performed while continuously tumbling said foodstuffs in said chamber.

2. The process of claim 1 wherein said inert gas of step (b) is other than argon and carbon dioxide and when added to said chamber forms a gaseous mixture within said chamber containing less than 1% argon.

3. The process of claim 1 wherein said inert gas of step (b) is other than argon and carbon dioxide and when added to said chamber forms a gaseous mixture within said chamber containing less than 1% argon and less than 0.5% carbon dioxide.

4. The process of claim 1 further comprising maintaining said chamber at said first reduced pressure in step (a) for a period of time ranging from 0.2 minute to 60 minutes before infusing said chamber with ozone gas.

5. The process of claim 1 further comprising maintaining said chamber at said first reduced pressure in step (a) from a period of time ranging from 0.5 minute to 10 minutes before infusing said chamber with ozone gas and maintaining said chamber after said ozone infusion and closing for a period of time ranging from 1 minute to 10 minutes.

6. The process of claim 1 further comprising maintaining said chamber at said first elevated pressure in step (b) for a period of time ranging from 0.5 minute to 60 minutes.

7. The process of claim 1 wherein said first elevated pressure of step (b) is from about 50 psia to about 200 psia, and step (b) further comprises maintaining said chamber at said first elevated pressure for a period of time ranging from 0.5 minute to 60 minutes.

8. The process of claim 1 wherein said first elevated pressure of step (b) is from about 50 psia to about 100 psia, and step (b) further comprises maintaining said chamber at said first elevated pressure for a period of time ranging from 1 minute to 10 minutes.

9. The process of claim 1 further comprising maintaining said second reduced pressure in step (c) for a period of time ranging from 0.5 minute to 30 minutes before contacting said foodstuffs with said mist of liquid disinfectant.

10. The process of claim 1 further comprising maintaining said second reduced pressure in step (c) for a period of time ranging from 0.5 minute to 30 minutes before contacting said foodstuffs with said mist of liquid disinfectant, and maintaining said second elevated pressure in step (c) for a period of time ranging from 0.5 minute to 60 minutes.

11. The process of claim 1 further comprising maintaining said second reduced pressure in step (c) for a period of time ranging from 1 minute to 10 minutes before contacting said foodstuffs with said mist of liquid disinfectant, and maintaining said second elevated pressure in step (c) for a period of time ranging from 1 minute to 10 minutes.

12. The process of claim 1 wherein:
said first reduced pressure is about 5 psia or less, said evacuation in step (a) to said first reduced pressure is performed in 5 seconds or less from atmospheric pressure, said first reduced pressure is maintained in step (a) for a period of time ranging from 0.5 minute to 10 minutes before infusing said chamber with ozone gas, said chamber is maintained closed in step (a) after said ozone infusion for a period of time ranging from 1 minute to 10 minutes,
said first elevated pressure is from about 50 psia to about 100 psia, said inert gas is added in step (b) at a rate in which said first elevated pressure is achieved within 10 seconds, and said first elevated pressure is maintained in step (b) for a period of time ranging from 1 minute to 10 minutes, and
said second reduced pressure is about 2 psia or less, said evacuation in step (c) to said second reduced pressure is performed in 5 seconds or less, said second elevated pressure is from about 50 psia to about 100 psia and said re-pressurization is achieved in 10 seconds or less, and said second elevated pressure is maintained for a period of time ranging from 1 minute to 10 minutes.

13. The process of claim 1 wherein said foodstuffs are a member selected from the group consisting of nuts, grains, vegetables, and seeds.

14. The process of claim 1 wherein said foodstuffs are almonds.

15. The process of claim 1 wherein said foodstuffs are grains.
